(19) United States
(12) Patent Application Publication
(10) Pub. No.: US 2026/0085766 A1
(43) Pub. Date: Mar. 26, 2026

(54) PILOT-OPERATED RELIEF VALVE ASSEMBLY

(71) Applicant: Emerson Automation Solutions Final Control US LP, Houston, TX (US)

(72) Inventors: Li Chen Chen, Shanghai (CN); Cao Juanjuan, Shanghai (CN); Liang Hongkang, Shanghai (CN)

(21) Appl. No.: 19/331,636

(22) Filed: Sep. 17, 2025

(30) Foreign Application Priority Data
Sep. 24, 2024 (CN) 202411332819.8

(51) Int. Cl. F16K 31/365; F16K 17/02

(52) U.S. Cl. CPC F16K 31/365; F16K 17/02

(57) ABSTRACT

A pressure relief valve assembly can include a valve body having a valve inlet and a valve outlet, a pilot valve, a dome, and a valve trim. The pilot valve can be arranged to control pressure in the dome based on a monitored pressure at the valve inlet. The valve trim can be arranged to be urged by pressure in the dome onto a seat within the valve body to prevent flow between the valve inlet and the valve inlet. The valve trim can include a flow channel that bypasses the pilot valve to fluidly couple the valve inlet and the dome.

### CROSS-REFERENCE TO RELATED APPLICATIONS

This application is based on and claims the benefit of priority from Chinese Patent Application No. 202411332819.8, filed on Sep. 24, 2024, which is hereby incorporated by reference in its entirety.

### BACKGROUND

Valve assemblies, including pilot-operated relief valves can be used in a variety of industrial, commercial, and other settings to relieve pressure from a system. In some applications, transient pressure events can lead to premature or otherwise undesired opening of a valve.

### SUMMARY

Some examples of the present disclosure provide a pressure relief valve assembly. The pressure relief valve assembly can include a valve body having a valve inlet and valve outlet, and a dome. A pilot valve can be arranged to control pressure in the dome based on a monitored pressure at the valve inlet. A valve trim can be arranged to be urged onto a seat within the valve body, by pressure in the dome, to prevent flow between the valve inlet and the valve inlet. The valve trim can include a flow channel that bypasses the pilot valve to fluidly couple the valve inlet and the dome.

Some examples of the present disclosure provide a valve trim for a pressure relief valve assembly. A main valve member can be movable to control flow between a valve inlet and a valve outlet of the pressure relief valve assembly, by seating on or lifting off of a main seat of the pressure relief valve assembly. A flow channel can extend through the main valve member. An intermediate valve can be arranged along the flow channel to control flow from an upstream side of the main valve member to a dome of the pressure relief valve assembly.

Some examples of the present disclosure provide a method of operating a pilot-operated pressure relief valve. operating a pilot-operated pressure relief valve. A pilot flow path can be provided, with a pilot valve, between a monitored pressure and a dome of the pilot-operated pressure relief valve. A trim flow path can be provided, between the monitored pressure and the dome, along a flow passage through a valve trim of the pilot-operated pressure relief valve, in parallel with the pilot flow path. With the pilot valve in a closed configuration to maintain pressure within the dome at the monitored pressure, upon an increase in the monitored pressure below a set pressure of the pilot-operated relief valve, an intermediate valve along the trim flow path can permit flow from the monitored pressure to the dome via the trim flow path. With the pilot valve in an open configuration to vent pressure from the dome, the intermediate valve can prevent flow from the monitored pressure to the dome via the trim flow path.

### BRIEF DESCRIPTION OF THE DRAWINGS

FIG. 1 is an axonometric view of a relief valve according to an example of the disclosed technology.

FIG. 2 is a cross-sectional view of the relief valve of FIG. 1 in a dome-loaded state.

FIG. 3 is a detailed view of a check valve of the relief valve of FIG. 2, the check valve in an open state.

FIG. 4 is a detailed view of the check valve of the relief valve of FIG. 2, the check valve in a closed state.

FIG. 5 is a cross-sectional partly schematic view of another relief valve according to an example of the disclosed technology.

### DETAILED DESCRIPTION

The concepts disclosed in this discussion are described and illustrated with reference to exemplary arrangements. These concepts, however, are not limited in their application to the details of construction and the arrangement of components in the illustrative examples and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

As noted above, relief valves can be used in a variety of industrial, commercial, and other applications to relieve fluid pressure form a system. Relief valves, such as pilot-operated relief valves, can have a set pressure at which a main valve member of the pilot-operated relief valve member opens to vent the monitored systems. During a valve opening event, due to elevated monitored pressures, fluid is thus permitted to flow from the valve inlet to the valve outlet. In contrast, until the monitored pressure (e.g., at the valve inlet) reaches or exceeds the valve set pressure, the main valve member is expected to remain closed.

In some pilot-operated pressure relief conventional valves, a sudden increase in pressure at the valve inlet can cause the main valve member to prematurely open, even when pressure of the monitored system does not exceed a set pressure. For example, a rapid increase in pressure at the valve inlet can occur during a startup event in which a fluid system is initially charged with a fluid pressure that is, in bulk, below the set pressure of the relief valve. However, a sensing line (e.g., a pitot tube) between the valve inlet and the pilot valve of the pilot-operated relief valve can transmit pressure between a sensing location and the corresponding dome with a temporal lag.

As a result, the main valve of the pressure relief valve may open briefly due to the transient system pressure increase, before the pilot valve is able to transmit sufficient pressure to a dome of the valve to balance the monitored pressure increase and reclose the valve. Accordingly, it may be useful to provide systems and methods for more directly pressurizing a dome of a valve, to bias a main valve member toward a closed position when the monitored pressure is below a set pressure, including during relatively sudden increases in pressure that may be conveyed with a lag by conventional pilot valve assemblies.

Conventional methods to counteract premature opening of a pilot-operated relief valve can include pre-loading a dome of a main valve. That is, the dome can be pre-pressurized before the relief valve is installed in the system or before the system is pressurized (e.g., can be pre-pressurized to the set pressure, or slightly below) Thus, dome pressure to prevent valve opening may not initially depend on the sensed pressure at the pilot valve, and the dome may correspondingly urge the main valve member toward the closed position as long as the monitored pressure is balanced by the pre-loaded dome pressure.

However, pre-loading a dome of a relief valve can have drawbacks. For example, after a relief event or other operation resulting in reduction in the pressure in the dome, the protection against pre-mature opening may be lost unless the dome is again pre-loaded. Repeated pre-loading operations may be expensive, time-consuming, or simply not practicable (e.g., for remote or expansive installations).

Embodiments of the disclosure can address these and other drawbacks of conventional valves and conventional methods for reducing premature valve opening, including as may result from a sudden increase in pressure, below a set pressure, at a valve inlet. For example, embodiments of the disclosure can provide a pilot-operated valve assembly having a direct flow channel extending between the valve inlet and the dome, rather than operatively through a pilot valve. For example, a channel through a spindle assembly can allow fluid from a monitored system to bypass the control of a pilot valve to flow from the valve inlet to the valve dome. Thus, the dome can be rapidly pressurized in response to sudden increases in monitored pressure (below a set pressure) to avoid premature opening of the valve.

In some examples, a channel to bypass a pilot valve can include an intermediate valve that selectively impedes the flow to the dome. Such an intermediate valve, for example, can help to ensure proper protection against overpressure by blocking flow along the flow path to the dome when the pressure at the inlet meets or exceeds the overall valve set pressure or when another relevant pressure condition is met.

In some examples, a channel to bypass a pilot valve can extend in particular through a valve trim of a pilot operated relief valve. For example, a flow channel can extend through a main valve member configured to seal the main valve of the relief valve, through a piston assembly or other spindle assembly for the main valve member, through a diaphragm of the main valve, or through various other components. Similarly, some examples can include an intermediate valve that is installed or formed in a main valve member, in a piston assembly or other spindle assembly for the main valve member, in various other components

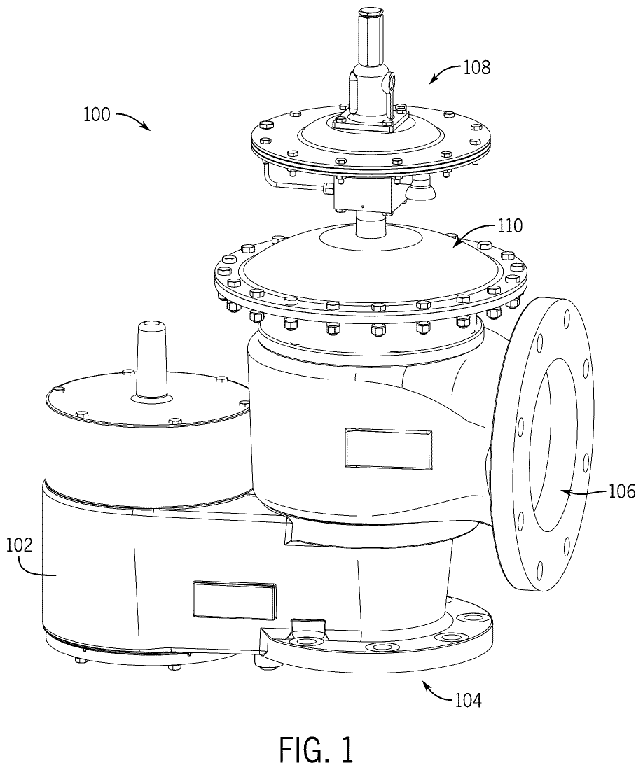

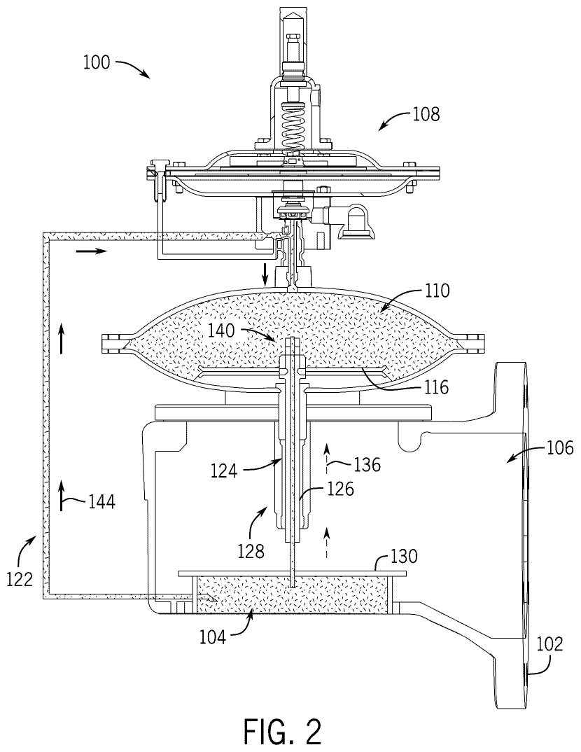

With reference now to the examples in the figures, FIG. 1 shows a pilot-operated relief valve assembly 100 according to an embodiment of the disclosure. The valve assembly 100 includes a main valve with a valve body 102, a valve inlet 104, a valve outlet 106, and a dome 110. Also shown in FIG. 1, the valve assembly 100 includes a pilot valve 108 in fluid communication with the valve inlet 104 and the dome 110. In general, the valve assembly 100 is configured to relieve fluid pressure at the valve inlet 104 when the pressure, as monitored by the pilot valve 108, reaches a set pressure of the valve assembly 100. More specifically, in use, when the pilot valve 108 senses the set pressure (e.g., at the valve inlet 104, as shown in FIG. 2), a pilot valve member opens to release pressure from the dome 110 (e.g., vent the pressure to atmosphere). A main valve member (e.g., piston) is thus permitted to lift off of a valve seat to open the main valve and exhaust pressurized fluid via the valve outlet 106.

As shown in FIG. 2, the valve assembly 100 is configured as a diaphragm-type pilot-operated relief valve and the dome 110 accordingly includes a diaphragm 116 engaged with a main valve member 130. Like some conventional pilot-operated relief valves, the dome 110 is in fluid communication with the pilot valve 108, and the pilot valve 108 is in fluid communication with the valve inlet 104 via a sensing path 122 (e.g., to sense a monitored pressure at the valve inlet 104, as shown).

As described above, in conventional valves, pressure communication between a pilot valve and a dome of a conventional pilot-operated relief valve is only facilitated by the sensing pathway between the valve inlet and the pilot valve 108. Therefore, for a conventional valve, when there is a sudden pressure increase at the valve inlet, the sensing path may not be able to relay the pressure change to—and through—the pilot valve and thereby to the dome with sufficient speed to keep the main valve member seated. This can then cause the main valve to briefly open and exhaust fluid even when the inlet pressure is below the set pressure.

As shown in FIG. 2, the valve assembly 100 further includes a flow channel 124 extending through a trim of the main valve. In particular, in the illustrated example, the flow channel 124 extends through a shaft 126 of a piston assembly 128 of the main valve, as well as through the diaphragm 116 and the main valve member 130. The flow channel 124 can accordingly supply fluid directly from the valve inlet 104 to the dome 110, bypassing the pilot valve 108. Accordingly, for example, during a sudden pressure increase of the monitored system (below the set pressure) the flow channel 124 can quickly transmit pressure to the dome 110 so that the main valve member 130 is not prematurely lifted from the valve seat.

In particular, for a given monitored pressure below the set pressure, the channel 124 can transmit pressure from the inlet 104 to the dome 110 faster than the sensing path 122 via the pilot valve 108. In this regard, for example, the valve assembly 100 can provide advantages over conventional pilot-operated relief valves. For example, a direct pathway between the inlet 104 and the dome 110 can more efficiently and effectively transmit pressure fluctuations at the inlet 104 to the dome 110, when the pressure at the inlet 104 is below the set pressure of the valve assembly 100, to thereby prevent (or reduce) unwanted valve-opening events.

In FIG. 2, the arrows 136 indicate a one-way direction of fluid flow from the inlet 104 to the dome 110 via the channel 124 in the shaft 126 of the piston assembly 128. Thus, for example, pressure from the dome 110 may be prevented from leaking back to the valve inlet 104, in the even the dome pressure exceeds the monitored pressure.

In general, although the combination of the sensing path 122 and the channel 124 provide parallel pressure communication from the inlet 104 to the dome 110, the channel 124 permits greater volumetric fluid flow to the dome 110 as compared to the sensing path 122, for a range of pressure differences between the monitored pressure and the dome 110 (e.g., at some or all monitored pressures below a set pressure for the valve 100). In some embodiments, the sensing path 122 can include a pitot tube with relatively small flow diameter and various bends, as well as the portions defined by the internal components of the pilot valve 108. Thus, the sensing path 122 may provide a relatively indirect flow path to communicate fluid pressure between the valve inlet 104 and the dome 110. In contrast, the channel 124 can provide a straight-path fluid passageway directly between an upstream side of the main valve member 130 and the dome 110, so that fluid at the valve inlet 104 can be efficiently channeled to the dome 110 to increase fluid pressure in the dome 110 as needed.

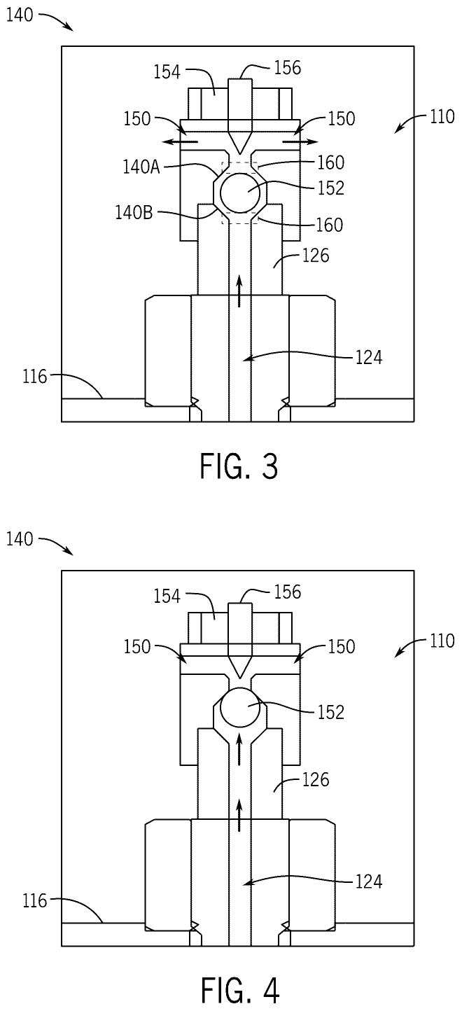

In some examples, as will be described below with reference to FIGS. 3 and 4, the valve assembly 100 further includes an intermediate valve 140. The intermediate valve 140 can permit flow from the inlet 104 to the dome 110 when the inlet pressure is below a set pressure of the valve assembly 100, while also preventing undesirable back flow from the dome 110 to the inlet 104. In contrast, the arrows 144 indicate the direction of flow from the inlet 104 to the pilot valve 108 along the sensing path 122. Thus, the combination of the sensing path 122 and the channel 124 can provide parallel flow and pressure communication from the inlet 104 to the dome 110, with flow as indicated by the arrows 136 bypassing the pilot valve 108 to pressurize the dome 110.

FIGS. 3 and 4 illustrate detailed views of an example configuration of the intermediate valve 140 within the piston assembly 128, although other valve assemblies to provide similar flow control can be used in other examples. In particular, FIG. 3 shows the valve 140 in an open position, in which a sealing member 152 (e.g., ball) is located between - and spaced apart from - a dome-side seat 140A and an inlet-or valve-side seat 140B. Accordingly, fluid flow is thus permitted from the inlet 104 to the dome 110 via the channel 124. In some examples, as also shown in FIG. 3, fluid flowing through the channel 124 can exit the valve 140 at valve outlets 150 that are positioned inside the dome 110 (e.g., with two of the outlets 150, extending in opposite directions, as shown).

In contrast, FIG. 4 shows the valve 140 in a closed position, in which the sealing member 152 is seated against the dome-side seat 140A. Accordingly, fluid flow from the inlet 104 (see FIG. 2) to the dome 110 via the channel 124 is prevented. In some examples, as further discussed below, the valve 140 can be configured to be moved to the closed position when the dome pressure is significantly below the monitored pressure (e.g., when the pilot valve 108 (see FIG. 2), is open to vent the dome 110). Thus, for example, the significantly higher pressure in the valve inlet 104 can cause the sealing member 152 to block flow from the valve inlet 104 to the dome 110 and the main valve can accordingly relieve the monitored pressure. In contrast, for example, the valve 140 can be configured to remain open when the pressure in the dome 110 is below, but relatively close to, the monitored pressure (e.g., during sudden increases in inlet pressure that remain below the set pressure of the relief valve 100, so that the pilot valve 108 remains closed to maintain pressure within the dome 110).

In particular, in the illustrated example of FIG. 3, the sealing member 152 is suspended in the flow through the intermediate valve 140 by local pressure forces corresponding to the relatively low flow rate through the valve 140. For example, the sealing member 152 can be suspended by local forces from turbulent eddies and other flow structures that may generally result from flow driven through the valve 140 by a relatively small pressure difference between the inlet 104 and the dome 104. In particular, in the example shown, the sealing member 152 can thus be suspended against the force of gravity. In contrast, in the illustrated example of FIG. 4, the relatively large pressure difference between the inlet 104 and the dome 110 may tend to induce a relatively large flow through the intermediate valve 140. This induced flow (and pressure difference) can then overcome suspension forces on the sealing member 152 (e.g., as in FIG. 3) to move the sealing member 152 to be seated on the dome-side seat 140A. In this regard, for example, the particular pressure differences at which the sealing member 152 can permit flow (e.g., as shown in FIG. 3) or block flow (e.g., as shown in FIG. 4) can be tuned during manufacture, installation, or service, as desired. For example, particular operational characteristics for the valve 140 can be provided by particular configuration of the flow passages thereof or through the adjustment of the size of relevant orifices (e.g., as further discussed below). In other examples, however, other flow structures or mechanical arrangements generally known in the art can be used to cause a sealing member to selectively permit or block flow between a monitored location and a dome.

As shown in FIGS. 3 and 4, in an example configuration, the intermediate valve 140 further includes an adjusting screw 156. In use, the adjusting screw 156 can be used to adjust the operating characteristics of the intermediate valve 140 by changing an orifice size within the flow channel 124 (i.e., to control a pressure drop across the valve 140, between the monitored pressure and the dome 110). Thus, through selected adjustment of the adjusting screw 156 (e.g., through threaded movement of the screw 156 relative to a body of the valve 140), a user can control a flow rate of fluid from the inlet 104 to the dome 110 for a given pressure difference between the two locations. Adjustment of the adjusting screw 156 can also correspondingly set a pressure difference between the inlet 104 and the dome 110, above which fluid is no longer allowed to flow through the channel 124 to the dome 110 (see FIG. 4). In the illustrated example, a lock nut 154 can be used to secure the adjusting screw 156 at a particular position, although other configurations are possible.

In some examples, a check valve or other intermediate valve within a bypass flow path can operate to block flow to the dome when a pilot valve is open to vent the dome, or when the dome pressure is otherwise substantially different from the monitored pressure (i.e., when the dome pressure is 50% or less of the monitored pressure). Thus, for example, the dome can be vented appropriately by the corresponding pilot valve for a relief event, in response to elevated monitored pressure. In contrast, a check valve or other intermediate valve can also operate to allow flow to the dome when the pilot valve is closed to maintain the dome pressure relative to the monitored pressure, or when the dome pressure is otherwise insubstantially different from the monitored pressure (i.e., when the dome pressure is 50% or more than the monitored pressure and less than or equal to the set pressure).

In some examples, whether an intermediate valve permits or blocks flow at particular pressure drops can be tuned based on a weight of a sealing member. For example, in the illustrated implementation fluid flows through the intermediate valve 140 to the dome 110 in an upward vertical direction. Correspondingly, the sealing member 152 may block flow through the intermediate valve 140 when the pressure difference between the dome 110 and the valve inlet 104 is sufficient so that the force of flow toward the sealing member 152—and the eventual corresponding static pressure difference across the sealing member 152—is sufficient to lift the sealing member 152 against gravity to be seated on the dome-side seat 140A. In other words, if the pressure force from the inlet 104 is larger than the pressure force from the dome 110 in combination with the force of gravity of the sealing member 152, the sealing member 152 can block flow through the valve 140. In contrast, the sealing member 152 may permit flow through the intermediate valve 140 when the pressure difference between the dome 110 and the valve inlet 104 is sufficient (i.e., large enough) to lift the sealing member off of the valve-side seat 140B, but not sufficient to seat the sealing member 152 against the dome-side seat 140A.

In some examples, a biasing member can be arranged to urge the sealing member 152 in a particular direction relative to a flow from the inlet 104 to the dome 110. For example, as shown in FIG. 3, a spring or other biasing element 160 can be arranged at an upstream or a downstream side of the sealing member 152 to bias the sealing member 152 toward a corresponding one of the seats 140A, 140B. The biasing element 152, for example, can be a spring of various types (e.g., a coil or wave spring), a composite body (e.g., a rubber ring or other composite resilient structure), or other structures known in the art for biasing valve elements relative to sealing contact. Inclusion of the biasing element(s) 160 may provide improved performance, for example, by allowing a selective reduction in pressure difference at which the sealing member 152 blocks flow between the inlet 104 and the dome 110, or improved sealing against flow between the inlet 104 and the dome 110 during valve pop. Or the biasing element(s) 160 may help to increase flow rate to the dome 110 when the pressure different between the dome 110 and the inlet 104 is relatively small.

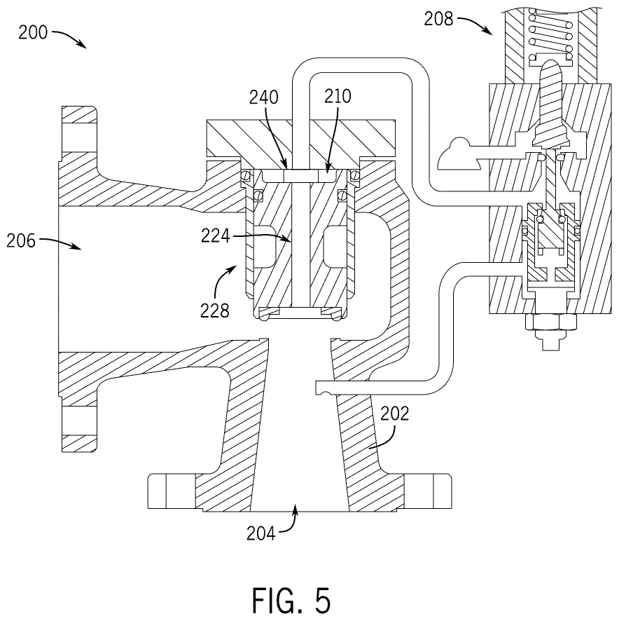

FIG. 5 shows another example, a pilot-operated relief valve assembly 200 according to an embodiment of the disclosure. Generally, the valve assembly 200 can operate similarly to the valve assembly 100 to monitor and relieve pressure, and discussion of the valve 100 above thus also generally applies to the valve 200. In some aspects, however, the valve assembly 200 is different from the valve assembly 100. For example, the valve assembly 200 a main valve with a valve body 202, a valve inlet 204, a valve outlet 206, and a pilot valve 208 configured to control pressure in a dome 210 of the main valve, similar to the valve assembly 100. In contrast to the valve assembly 100, however, the valve assembly 200 include a dome 210 that is not separated from the valve inlet 204 by a diaphragm. Rather, the valve trim of the valve assembly 200 includes a piston assembly 228 is formed as a movable piston (main valve) body that is directly exposed to pressure in the dome 210 at a dome-side of the piston body and seats on a valve seat of the valve body 202 at a valve-side of the piston body.

As shown in FIG. 5, similar to the valve assembly 100, the valve assembly 200 includes a flow channel 224 that extends through the valve trim to the dome 210, bypassing the pilot valve 208. Further, in some cases an intermediate valve 240 can be arranged along the flow channel 224 (e.g., at a downstream end, thereof) to selectively permit or prevent flow along the flow channel 224 from the valve inlet 204 to the dome 210. For example, the valve 240 can be configured similarly to the valve 140, as discussed in detail above, to allow rapid transmission of pressure fluctuations (below the set pressure) from the valve inlet 204 to the dome 210.

Thus, examples of the disclosed technology can provide improved pressure relief valve assemblies, improved trims for relief valves, and improved methods for operating relief valves. In particular, some examples can provide improved transmission of pressure fluctuations in monitored pressure to a dome of a pilot operated relief valve (e.g., through flow passages that bypass the corresponding pilot valve). Thus, for example, a corresponding relief valve may be generally prevented from opening in response to fluctuations in monitored pressure that do not exceed a set pressure of the relief valve.

In some implementations, devices or systems disclosed herein can be utilized, manufactured, installed, etc. using methods embodying aspects of the disclosed technology. Correspondingly, unless otherwise indicated, any description herein of particular features, capabilities, or intended purposes of a device or system is intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated, discussion herein of any method of manufacturing or using for a particular device or system, including installing the device or system, is intended to inherently include disclosure, as examples of the disclosed technology, of the utilized features and implemented capabilities of such device or system.

Some methods of the disclosed technology may be presented above or below with operations listed in a particular order. Unless otherwise required or specified, the operations of such methods can be implemented in different orders, in parallel, or as selected sub-sets of one or more individual operations (e.g., with a particular listed operation being implemented alone, rather than in combination with others).

As noted above, the figures within this disclosure are by way of examples, and features described herein or others may be used in other relief valve configurations. Thus, examples of the disclosed technology can provide an improvement over conventional systems and methods for accommodating rapid pressure increases at a valve inlet. The previous description of the disclosed examples is provided to enable any person skilled in the art to make or use the disclosed technology. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C”indicate options of: A and B; B and C; A and C; and A, B, and C.

Also as used herein, unless otherwise limited or defined, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or other continuous single piece of material, without rivets, screws, other fasteners, or adhesive to hold separately formed pieces together, is an integral (and integrally formed) element. In contrast, an element formed from multiple pieces that are separately formed initially then later fastened together, is not an integral (or integrally formed) element.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order. Relatedly, similar or identical components may be referred to with different ordinal numbers in different contexts.

Also as used herein, unless otherwise limited or defined, “configured to” indicates that a component, system, or module is particularly adapted for the associated functionality. Thus, for example, a ZZ configured to YY is specifically adapted to YY, as opposed to merely being generally capable of doing so.

Although the presently disclosed technology has been described with reference to preferred examples, workers skilled in the art will recognize that changes may be made in form and detail to the disclosed examples without departing from the spirit and scope of the concepts discussed herein.

1. A pressure relief valve assembly, comprising:
a valve body having a valve inlet and valve outlet;
a dome;
a pilot valve arranged to control pressure in the dome based on a monitored pressure at the valve inlet; and
a valve trim arranged to be urged onto a seat within the valve body, by pressure in the dome, to prevent flow between the valve inlet and the valve inlet; and
the valve trim including a flow channel that bypasses the pilot valve to fluidly couple the valve inlet and the dome.

2. The pressure relief valve assembly of claim 1, further comprising:
an intermediate valve within the flow channel, the intermediate valve permitting one-way flow along the flow channel, from the valve inlet to the dome, when the monitored pressure is at or below a set pressure of the pressure relief valve assembly.

3. The pressure relief valve assembly of claim 2, wherein the intermediate valve blocks flow along the flow channel, from the valve inlet to the dome, when the monitored pressure is above the set pressure of the pressure relief valve assembly.

4. The pressure relief valve assembly of claim 2, wherein the intermediate valve includes:
a dome-side seat;
a valve-side seat; and
a sealing member movable between seated positions on:
the valve-side seat, to block flow along the flow channel from the dome to the valve inlet; and
the dome-side seat, to block flow along the flow channel from the valve inlet to the dome.

5. The pressure relief valve assembly of claim 2, wherein the intermediate valve includes:
a sealing member movable in response to pressure difference between the dome and the monitored pressure to block flow along the flow channel from the valve inlet to the dome; and
an adjusting screw that is rotatable to adjust an orifice size within the flow channel for flow from the valve inlet to the dome.

6. The pressure relief valve assembly of claim 5, wherein the adjusting screw extends into the dome.

7. The pressure relief valve assembly of claim 5, wherein the intermediate valve includes a plurality of outlets disposed within the dome to direct flow from the flow channel into the dome.

8. The pressure relief valve assembly of claim 1, wherein the valve trim further includes:
a main valve member movable to a valve-open position to permit flow between the valve inlet and the valve outlet and to a valve-closed position to block flow between the valve inlet and the valve outlet; and
a piston assembly arranged to move the main valve member between a valve-open position and a valve-closed position;
wherein the flow channel extends through the main valve member and the piston assembly.

9. The pressure relief valve assembly of claim 8, wherein the piston assembly is engaged with a diaphragm of the dome to move the main valve member between the valve-open position and the valve-closed position; and
wherein the flow channel extends through the diaphragm into the dome.

10. The pressure relief valve assembly of claim 1, wherein a pilot flow path extends between the valve inlet and the dome via the pilot valve, in parallel with the flow channel; and
wherein, with the monitored pressure below a set pressure of the pressure relief valve assembly, the flow channel provides flow from the valve inlet to the dome with a higher volumetric flow rate than the pilot flow path.

11. A valve trim for a pressure relief valve assembly, the valve trim comprising:
a main valve member that is movable to control flow between a valve inlet and a valve outlet of the pressure relief valve assembly, by seating on or lifting off of a main seat of the pressure relief valve assembly;
a flow channel extending through the main valve member; and
an intermediate valve arranged along the flow channel to control flow from an upstream side of the main valve member to a dome of the pressure relief valve assembly.

12. The valve trim of claim 11, further comprising:
a piston assembly configured to move a main valve member to seat on or lift off of the main seat in response to pressure in the dome of the pressure relief valve assembly;
wherein the flow channel further extends through the piston assembly, to provide a flow path through the main valve member and the piston assembly, between the upstream side of the main valve member to a dome end of the piston assembly.

13. The valve trim of claim 11, wherein the intermediate valve includes a sealing member that is movable in an upward direction along the flow channel to seat on a dome-side seat of the intermediate valve and block flow to the dome.

14. The valve trim of claim 13, wherein the intermediate valve further includes a valve-side seat, and wherein the sealing member is movable between the dome-side seat and the valve-side seat to selectively permit or block flow through the flow channel based on a pressure difference between the upstream side of the main valve member and the dome.

15. The valve trim of claim 11, wherein the intermediate valve includes an adjusting screw that is rotatable to adjust an orifice size within the flow channel to control a flow rate from the upstream side of the main valve member to the dome.

16. A method of operating a pilot-operated pressure relief valve, the method comprising:
providing a pilot flow path with a pilot valve, between a monitored pressure and a dome of the pilot-operated pressure relief valve; and
providing a trim flow path between the monitored pressure and the dome, along a flow passage through a valve trim of the pilot-operated pressure relief valve, in parallel with the pilot flow path;
wherein, with the pilot valve in a closed configuration to maintain pressure within the dome at the monitored pressure, upon an increase in the monitored pressure below a set pressure of the pilot-operated pressure relief valve, an intermediate valve along the trim flow path permits flow from the monitored pressure to the dome via the trim flow path; and
wherein with the pilot valve in an open configuration to vent pressure from the dome, the intermediate valve prevents flow from the monitored pressure to the dome via the trim flow path.

17. The method of claim 16, further comprising:
adjusting a set screw within the dome to adjust a flow rate through the intermediate valve into the dome.

18. The method of claim 17, wherein adjusting the set screw changes an orifice size within the trim flow path to control a pressure drop across the intermediate valve between the monitored pressure and the dome.

19. The method of claim 16, wherein the intermediate valve includes a sealing member that moves between a dome-side seat and a valve-side seat to selectively permit or block flow through the trim flow path based on a pressure difference between the monitored pressure and the dome.

20. The method of claim 16, wherein the trim flow path extends through a main valve member and a piston assembly of the valve trim, and wherein the trim flow path provides a higher volumetric flow rate from the monitored pressure to the dome than the pilot flow path when the monitored pressure is below the set pressure.
